(19) United States
(12) Patent Application Publication
(10) Pub. No.: US 2009/0307133 A1
(43) Pub. Date: Dec. 10, 2009

(54) Online Payment System for Merchants

(76) Inventors: Daniel Lee Holloway, Auckland (NZ); Albert Anderson, Auckland (NZ)

Correspondence Address: JACOBSON HOLMAN PLLC, 400 SEVENTH STREET N.W., SUITE 600, WASHINGTON, DC, 20004, US

(21) Appl. No.: 11/922,346

(22) PCT Filed: Jun. 16, 2006
(86) PCT No.: PCT/NZ2006/000157

§ 371 Date: Jul. 9, 2009

(30) Foreign Application Priority Data
Jun. 17, 2005 (NZ) 540853

(51) Int. Cl. G06Q 20/00; G06Q 40/00

(52) U.S. Cl. 705/44; 705/35; 705/39

(57) ABSTRACT

A payment system that utilises the Internet to gain access to an Internet banking system enabling a user to purchase merchandise bought through an online merchant or merchant who has Internet access in their store is disclosed. The payment system may also be utilised to provide a means for a user to retrieve and view balances and account transaction information for their bank accounts and to transfer funds between accounts. The system uses a “virtual pin-pad” which provides a web-based, stand-alone method of payment that is independent of banks and capable of performing real-time currency conversions.

### BACKGROUND OF THE INVENTION

1. Field of the Invention

This invention relates to a system and method for making a payment of goods and/or services using an electronic system and in particular though not solely to a system and method for undertaking a financial transaction using an online computerised system and/or paying for goods and/or services purchased from an online merchant.

2. Summary of the Prior Art

The use of electronic systems to pay for goods and service has increased exponentially over the past decade. A person who wishes to purchase goods is now capable of undertaking a purchasing transaction without needing to leave their home. The purchaser will generally gain access a merchant web-site using the Internet; select the item desired and purchase the goods by entering credit card information. The merchant then confirms the person's credit card information and forwards the goods to the person by mail, courier or other physical delivery methods. Whilst this system works well, it is subject to a number of problems such as; the security of the transaction and the merchant being at risk in the event the purchaser does not have adequate funds to cover the cost of their purchase.

Electronic Funds Transfer Point of Sale (EFTPOS) terminals provides merchants with immediate notification of whether or not adequate funds are available in a purchaser's bank account. Hence, in the event that the purchaser has insufficient funds available, a transaction declined message will be displayed at the EFTPOS terminal. Similarly, if adequate funds are available, a message is displayed indicating that the transaction has been accepted and the EFTPOS terminal prints out a receipt. The disadvantages with the EFTPOS terminal are that; the purchaser has to be physically at the merchants premises; the purchaser is at risk of having their pin number “stolen” and their bank account fraudulently accessed by another person; the system is restricted to credit, debit and savings account transactions; the provision of the EFTPOS terminal and set-up service is expensive for the merchant; there is the additional expense the cost of installing, maintenance and upgrade fees; and, there is only one level of security which is via the purchaser entering their pin number.

In US2004/0139005 in the name of Checkfree Corporation, a cashless transaction system is disclosed which enables purchases to be made either in person at a retail outlet or online using the Internet, without a credit card, debit card or a cheque. For Internet purchases, user identifier information is received at the seller's network and transmitted over a second network to a central processing point for processing to ensure the purchaser is a registered purchaser. The user identifier information is used to verify the identity of the purchaser instead of the purchaser having to reveal bank access details or other general bank account information. Once it is confirmed that the purchaser is registered, the seller generates a digital bill which is transmitted to the purchaser and the central processor where it is confirmed that the purchaser has adequate funds to pay for the goods. One of the disadvantages of this system is that it requires every purchaser to be registered in order to utilise this cashless facility and as such the purchaser will have to divulge their details during the registration process thereby potentially increasing the purchaser's vulnerability to possible fraudulent behaviour.

A secure system and method for shopping on the Internet without the purchaser having to reveal account information to the vendor is disclosed in U.S. Pat. No. 6,704,714 assigned to The Chase Manhatten Bank. Vendors receive immediate payment confirmation through an Electronic Funds Transfer (EFT) network enabling the vendor to ship products with the knowledge that the payment has already been received. The system uses a Payment Portal Processor (PPP) software application that augments any Internet browser having an e-commerce capability. The software provides a secure portal for linking to the user's accounts and enabling the user to ‘push’ electronic credits from their accounts to any other account through the EFT network. The PPP enhanced wallet stores various types of user information such as credit card and debit card numbers, shipping addresses, email address and frequent flyer programmes, which ultimately reduces the amount of “form filling” a user has to undertake when entering into an online purchasing transaction. The system, whilst purporting to be secure, enables the user to push funds directly from their personal accounts into the merchants account. The disadvantage of this system is that there may be no guarantee as to the authenticity of the vendor or that the goods will actually be dispatched.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY OF INVENTION

It is an object of the present invention to provide a user activated payment system and/or method to augment existing payment systems which will at least go some way towards overcoming or at least ameliorates some of the abovementioned disadvantages or which will at least provide the industry or the public with a useful choice.

Accordingly, in a first aspect, the present invention consists in a user activated payment system for use when purchasing goods and/or services from a remote computerised vendor system comprising:

an electronic input means providing said user with a means to provide input to said remote computerised vendor system,

a virtual terminal residing on said remote computerised vendor system capable of being activated by said user using said electronic input means, to undertake financial transactions under the control of a third party transaction system,

at least one database record located on said third party transaction system corresponding to the said user's identity and used to identify said user and sending said user a unique user specified word for display on said virtual terminal corresponding to said user's identity thereby enabling said user to operate said virtual terminal to undertake said financial transactions.

Preferably, said at least one database record on said third party transaction system is used to record a user's details including a unique word which is specified by said user and is displayed on said virtual terminal prior to said financial transactions being performed enabling said user to verify their identity.

Preferably, said unique user specified word is a sequence of alpha-numeric characters.

Preferably, said unique user specified word is a sequence of alpha-numeric characters which is transformed into a unique image.

Preferably, said virtual terminal will be deactivated by said user if said user specified word displayed on said virtual terminal does not correspond to said unique user specified word recorded in said at least one database record.

Preferably, said virtual terminal comprises at least a data input means, an account selection means, user functionality means and a user feedback means.

Preferably, said data input means comprises a plurality of virtual alpha-numeric keys.

Preferably, said account selection means includes a plurality of virtual financial account keys.

Preferably, said virtual financial account keys enable said user to select to undertake said financial transaction by selecting either a cheque account, a credit account or a savings account from which funds can be withdrawn.

Preferably, said functionality means includes a plurality of keys which when activated, enable said user to perform a plurality of actions such as erasing information, exiting a particular transaction and terminating a transaction session.

Preferably, said user feedback means comprises a virtual display.

Preferably, said virtual terminal can be customised to meet a merchant's business requirements.

In a second aspect, the invention consists in a method of undertaking a user activated payment for making financial transactions online on gaining access to a remote computerised vendor system comprising the steps of:

activating a virtual terminal on said remote computerised vendor system,

inputting data on said virtual terminal to undertake a financial transaction with said remote computerised vendor system via a third party transaction system, wherein said user inputs data to said virtual terminal to select a financial institution which provides an online financial transaction service through which said user performs all their financial transactions and on selection said user may perform a financial transaction in order to purchase goods and/or services using said third party transaction system as a payment gateway and on completion of said financial transaction deactivating said virtual terminal.

Preferably, said step of activating said virtual terminal is by said user activating a web-based browser window from within a web-page activated on said remote computerised vendor system.

Preferably, said step of inputting data on said virtual terminal causes said virtual terminal to interact with said third party transaction system to provide a payment gateway between said user and said remote computerised vendor system.

Preferably, said step of performing said financial transaction is completed when said third party transaction system provides said remote computerised vendor system with a valid transaction indication.

Preferably, said step of inputting data on said virtual terminal requires said third party transaction system to temporarily store in a database said user's financial transaction information.

Preferably, said step of inputting data on said virtual terminal requires said third party transaction system to provide a means of enabling said user to validate their identity via said virtual terminal.

Preferably, said step of inputting data enables said user to validate their identity when said third party transaction system sends a word for display on said virtual terminal whereby said word corresponds to a word determined by said user during a system registration process enabling said user to proceed with said financial transaction.

Alternatively, said step of inputting data enables said user to not validate their identity if said word sent by said third party transaction system does not correspond to said word determined by said user during said system registration enabling said user to terminate said financial transaction.

In a third aspect, the invention consists in a method of making a financial transaction online using a virtual terminal activated from a web-based system residing on a remote computerised vendor system comprising the steps of:

selecting a product and/or service online from said web-based system activated on said remote computerised vendor system,

activating said virtual terminal from said web-based system,

selecting a financial institution and an account type from a menu on said virtual terminal,

inputting on said virtual terminal a user's primary authentication information enabling said user to gain access to said account type,

receiving and displaying a user verification data on said virtual terminal,

verifying said user verification data,

receiving and displaying a security certificate which is common to each web-based site interacting with said user,

verifying said security certificate each time said user interacts with each of said web-based site,

confirming details of said financial transaction,

receiving a confirmation that said financial transaction has been accepted, and

deactivating said virtual terminal on completion of all of said transactions.

Preferably, said step of receiving a confirmation requires said third party transaction system to sends a transaction acknowledgement to said remote computerised vendor system enabling said remote computerised vendor system to complete a user purchase transaction.

Preferably, said step of inputting a user's primary authentication information includes said user inputting a user card number and a form of a coded user identifier information.

Preferably, said step of inputting a user's primary authentication information includes said coded user identifier information comprising a user name and/or password.

Preferably, said step of confirming details of said transaction requires said user to confirm said transaction type is a purchase payment for goods and/or services.

Alternatively, said step of confirming details of said transaction requires said user to confirm said transaction type is a balance query in relation to one of said account types.

Preferably, said step of verifying said user verification data requires said user to verify a word specified by said user when said user becomes a registered user of said third party transaction system is correct.

Preferably, said step of verifying said verification data requires said third party transaction system to code said user specified word into a form which said user can understand before sending said user specified word to said virtual terminal for said user to verify as being their user specified word.

Preferably, said step of verifying said verification data requires said user to deactivate said virtual terminal if said user specified word does not correspond to said user specified word sent to said virtual terminal.

Preferably, said step of verifying said security certificate requires said user to verify a uniquely generated session graphic common to each of said web-based sites interacting with said user enabling said user to verify and authenticate said web-based sites.

Preferably, said step of verifying said security certificate requires said user to deactivate said virtual terminal is said uniquely generated session graphic does not correspond to said uniquely generated session graphic common to each of said web-based sites interacting with said user.

Preferably, said step of selecting an account type requires said user to select a debit account.

Alternatively, said step of selecting an account type requires said user to select a credit account.

Alternatively, said step of selecting an account type requires said user to select a savings account.

A number of terms have been used in the description of the invention which are generally defined as follows:

“Issue number” refers to a number which may be appended to a payment cards for example, used by the card issuing authority to track details of when and to whom the card is issued.

“CVV2” or “CV2” or “CVC2” is the Credit Card Verification Value appended to the back of a credit card and is unique to each card and customer.

“PIN” is a Personal Identification Number which is user specified number (normally four digits in length).

“Session” refers to an online connection session established on a server and recorded in a database.

“APV” stands for All Party Verification.

“MITM” stands for Man-In-The-Middle.

“PV” stands for Phone Verification.

“SMS” stands for Short Message Service.

“XML” stands for Extensible Markup Language.

“HTTP” stands for Hypertext Transfer Protocol.

“POST” refers to a method of encoding data to a server prior to the submission of a form to a server. A POST encodes the form data into a message/content body, and

“SOAP” is a Simple Mail Transport Protocol which uses XML as a structure for encoding a service request, response and error messages.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

This invention consists in the foregoing and also envisages constructions of which the following gives examples.

### BRIEF DESCRIPTION OF THE DRAWINGS

The invention will now be described by way of example only and with reference to the accompanying drawings in which;

FIG. 1 is a schematic block diagram of the hardware components forming the online payment system according to a preferred embodiment of the present invention,

FIG. 2 is a diagram of a merchant checkout web-page used to initiate the virtual terminal in the system of FIG. 1,

FIG. 3 illustrates a sequence diagram applied to the online payment system of FIG. 1,

FIG. 4 is a diagram of a virtual terminal used to select a payment type in order to undertake a transaction in the system of FIG. 1,

FIG. 5 is a diagram of a virtual terminal as used to select a financial services provider in order to draw-down funds to undertake a financial transaction in the system of FIG. 1,

FIG. 6 is a diagram of a virtual terminal as used to gain access to a selected a financial services provider in order to draw-down funds to undertake a financial transaction in the system of FIG. 1,

FIG. 7 is a diagram of a virtual terminal requiring a user to confirm the financial transaction displayed on the virtual terminal in the system of FIG. 1,

FIG. 8 is a diagram of a virtual terminal showing the display of a customer's unique special word used for user verification purposes in the system of FIG. 1,

FIG. 9 is a diagram of a virtual terminal display showing a close-up view of a customer's unique special word used for user verification purposes in the system of FIG. 8,

FIG. 10 is a diagram of an example of an all party verification graphic used to verify the authentication of each party using the system of FIG. 1,

FIG. 11 is a diagram of the phone verification system used to provide two channel user verification using the system of FIG. 1,

FIG. 12 is a diagram of a virtual terminal displaying the unique session identifier used for additional user verification purposes in the system of FIG. 1, and

FIG. 13 illustrates a sequence diagram applied to the online payment system using the two channel user verification method for use in the system of FIG. 1.

### DETAILED DESCRIPTION OF THE INVENTION

The present invention provides a payment system that utilises the Internet to gain access to an Internet banking system enabling a user to purchase merchandise bought through an online merchant or merchant who has Internet access in their store. The payment system of the present invention may also be utilised to provide a means for a user to retrieve and view balances and account transaction information for their bank accounts and to transfer funds between accounts.

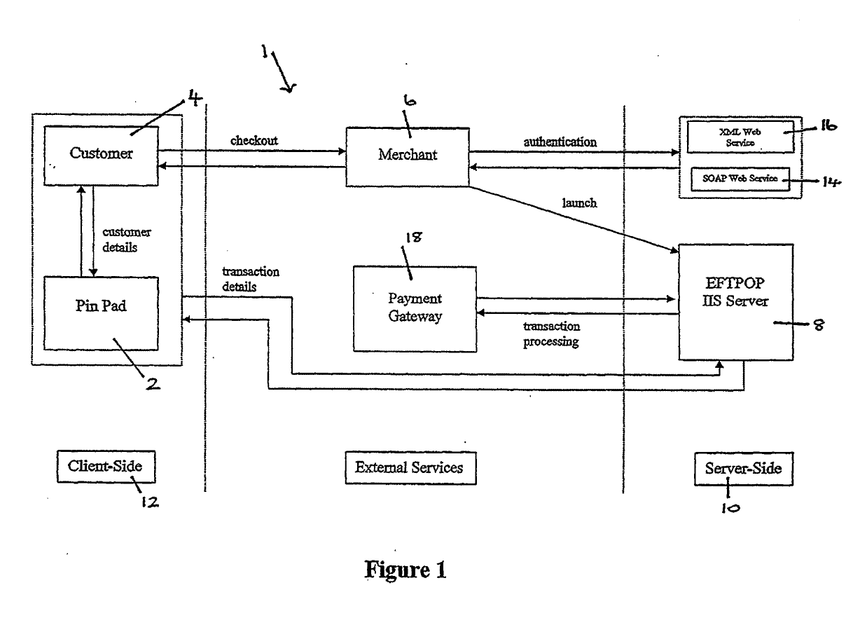

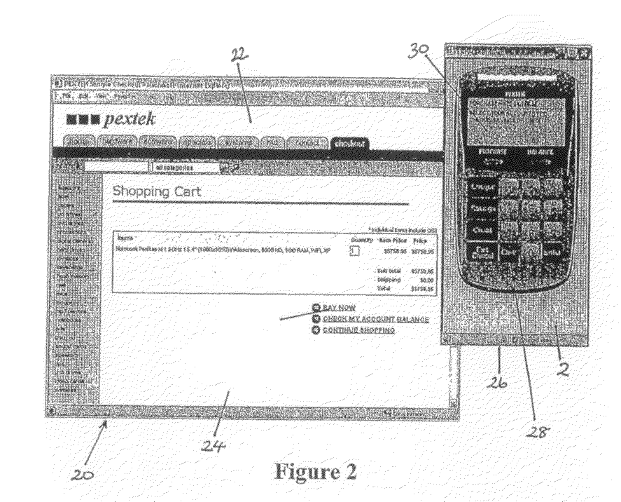

With reference to FIGS. 1 and 2, included in the payment system 1 of the present invention is a ‘virtual pin-pad’ 2 which provides a web-based, stand-alone method of payment that is independent of banks and capable of performing real-time currency conversions. The virtual pin-pad 2 is preferably activated via a browser window 22 and has the appearance of a conventional Electronic Funds Transfer Point of Sale (EFTPOS) terminal keypad. The virtual pin-pad 2 enables a customer 4 to perform conventional EFTPOS type transactions from a personal computer (PC) or through a merchant 6 who has access to the Internet and has availed themselves of the payment system 1 of the present invention.

The payment system 1 and virtual pin-pad 2 of the present invention have similar functionality to that provided by conventional EFTPOS terminals; however, the virtual pin-pad 2 is accessed and used via the Internet in order to undertake financial transactions with a merchant for example. The details entered by the user are validated by the EFTPOP Server 8 (server-side) 10 prior to processing the transaction along with customer validation (client-side) 12 to prevent fraudulent use or data input errors. On obtaining authorisation to proceed with a purchase transaction the merchant server 6 will launch the virtual pin pad 2 onto the customer's display 20 enabling financial transactions to be undertaken.

### Payment Transaction

When a customer 4 wishes to purchase goods and/or services from an online merchant 6, the customer 4 uses their PC to gain access to the Internet to initiate a merchant's web-page 22. In the event that the customer 4 wishes to purchase products and/or services from the merchant, the customer 4 initiates the launch of the virtual pin pad 2 from the merchant's checkout web-page 24. The virtual pin pad 2 is an independent web-browser window resized for the virtual pin-pad web-page 26 positioned on top of the merchant checkout page 24. The virtual pin-pad 2 is capable of being launched in a particular mode of operation as desired by the customer 4 such as, debit payment only and/or credit card payment only, for example. However, the virtual pin-pad system 2 is capable of having the credit or debit part of the virtual pin-pad 2 disabled and is set on a per-merchant basis. It is therefore the merchant's decision as to whether or not to enabled both credit and debit functions and can choose to enable only one if required, for example to work within an existing system or business framework. If both credit and debit functionality is available, the link to the virtual pin-pad 2 will indicate either by text or by an icon to initiate a debit (or credit) payment mode. The debit payment mode may also be achieved by pressing the “Cheque” 32 or “Savings” 34 key, the “Credit” 36 or “Clear” 28 key on the virtual pin-pad 2 until the pin-pad 2 reaches a prompt on the virtual pin-pad display 30 asking the customer 4 for the payment type. Hence, the customer 4 has the ability to change between credit and debit payment methods during a virtual pin-pad session.

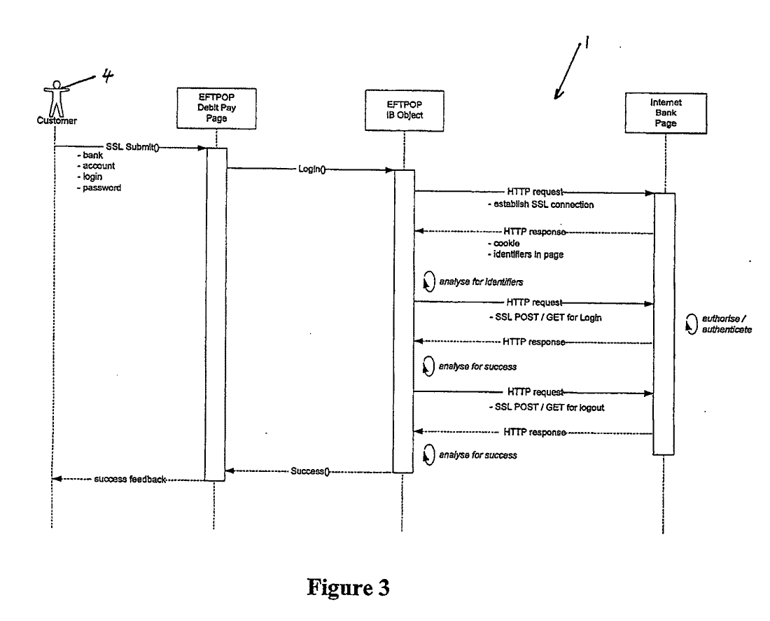

As illustrated in FIGS. 2 and 3, in order to load the virtual pin-pad 2, the merchant check-out web-page 24 must request an Authentication Token from the server-side servers 8. Once the merchant's servers 6 receive and process a valid request and response then an Authentication Token can be obtained from the server-side servers 8. The token must then be submitted as a form-field within an HTTP POST which contains all the transaction information including the Authentication Token and merchant details which are validated by the server-side servers 8. Once the token is submitted the virtual pin-pad 2 is loaded inside the independent positionable browser window 26.

The virtual pin-pad 2 securely collects the customer's details required to undertake a financial transaction on behalf of the merchant 6. The handling of messages between the virtual pin-pad 2 and the server-side database and web-servers 8 is via a secured connection only and data input by the customer 4 is validated and encrypted within the browser 26 before being passed to the server-side servers 8. Any information sent from the server-side servers 8 are interpreted by the virtual pin-pad 2 and so that the customer 4 can be informed of the result of the transaction processing. On the completion of transaction processing the virtual pin-pad 2 performs an HTTPS POST and/or an HTTP POST transaction back to the merchant web-site 22 to provide an indication of the result of the financial transaction such as for example, transaction “accepted”.

Once the customer 4 has completed their interaction with the virtual pin-pad 2 to undertake the financial transaction the customer 4 has the option of returning to a merchant web-page 22 behind the virtual pin-pad 2 independent browser window. The merchant web-page 22 handles the transaction response passed back to it from the server-side servers 8 on completion of the customer's input via the virtual pin-pad 2, and will enable the merchant 6 to proceed with order processing on the receipt of a successful transaction notification. Throughout the processing transaction, the customer's Internet Banking credentials do not pass and are not shared with the merchant system.

Debit payment functionality encompasses everything involving the collection of the customers Internet Banking credentials to facilitate a debit payment from a customers Internet Banking provider. The customer 4 also has the ability to use the virtual pin-pad system 2 to provide balance retrieval functionality whereby the virtual pin-pad 2 uses and collects similar credentials as those used for debit payments; however, the customer information is then used to facilitate the retrieval of one or more of the customer's bank account balance(s) from the customers Internet Banking provider. Hence, for both debit payments and balance retrieval the secure customer detail collection processes are essentially the same.

### Payment Steps

The virtual pin-pad is capable of being launched by four methods such as:

a. Debit Payment Hyperlink.

b. Credit Payment Hyperlink.

c. Pay Now Hyperlink.

d. Directly from an EFTPOP web-site.

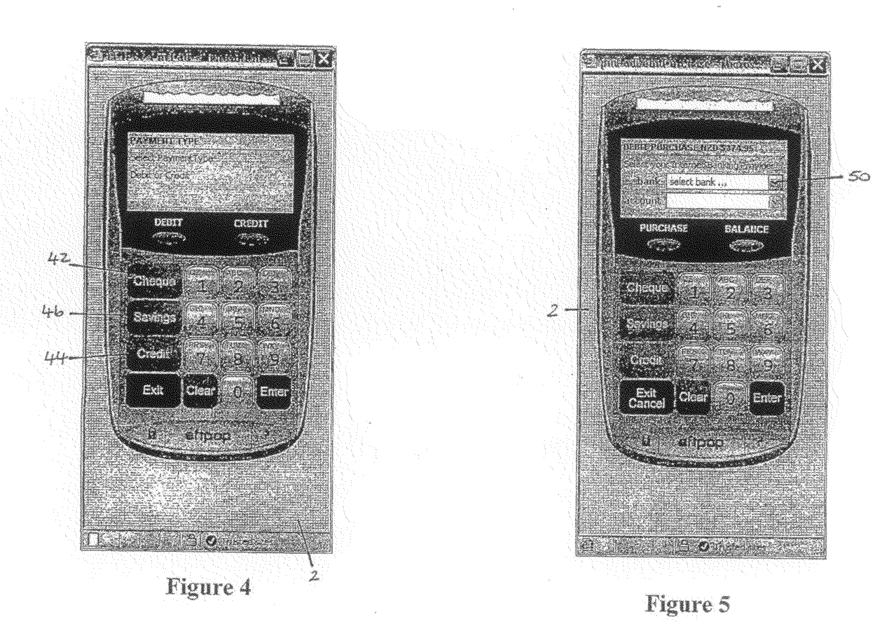

The pay now hyperlink 38 takes the customer 4 straight to the Payment Type display page 40 as shown in FIG. 4. The customer 4 must first select their Internet Bank from the Bank dropdown control menu 50 as shown in FIG. 5. Only those Internet Banks that have registered to use the online payment system 1 will be listed in the dropdown control menu 50 and enable debit payment functionality. If a customer bank is not found on the Bank dropdown selection list 50 and as such not supported, the customer 4 has the option of continuing with the transaction but changing the payment method, for example from debit 32, 34 to credit 36; however, this option is dependant on the merchant enabling this payment method.

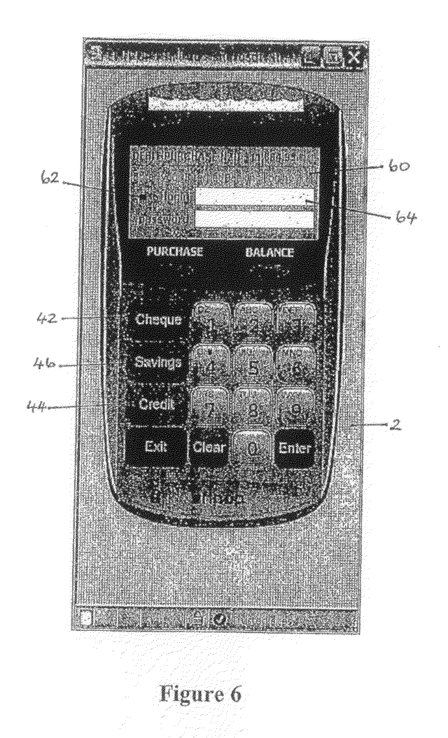

With reference to FIG. 6, depending on the Internet Bank selected, the customer 4 will be given a login prompt 60 for which the details are equivalent to their Internet Bank Login prompt such as user name and password or some other form of user specific coded data input. The customer 4 is also given the option of masking their login by clicking on a “lock” icon 62 that is situated next to the login text-box label 64. Clicking the icon 62 toggles between the masked state and the unmasked state for data entry in the Login textbox 64. Once the login details are validated, the customer 4 is required to select an account type such as cheque 32, savings 34 or credit 36 using the relevant keys displayed on the virtual pin-pad 2.

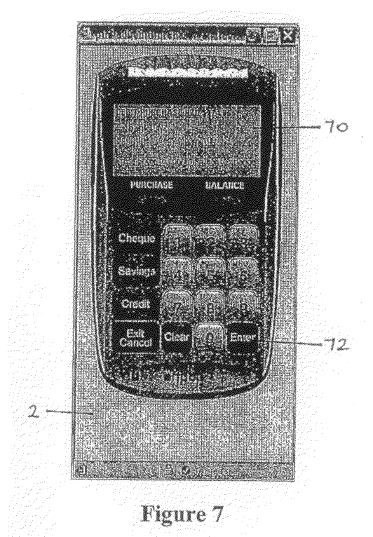

Once the customer's details are input and validated, the virtual pin-pad 2 will display a summary of the transaction 70 to be undertaken and request the customer 4 to confirm the transaction as shown in FIG. 7. If the customer indicates confirmation by pressing the “Enter” key 72 thereby enabling the transaction to proceed to the processing stage. After the transmission of the customer details from the virtual pin-pad 2 via a secure link to the server-side servers 8 these details are further transmitted via a secure link to the Internet Banking Processing Component installed on the financial institution servers 8. In order to maximize security for each customer, the customer's details are held in the server-side server memory 8 in an encrypted form, only long enough to complete a particular financial transaction. Once the Debit Payment Transaction Processing has been completed for example, a result of the transaction such as, “accepted” or “declined”, will be displayed on the virtual pin-pad display.

### EFTPOS Payments

Where a customer 4 chooses to use an EFTPOS card or and Automatic Teller Machine (ATM) card as the source of their payment credentials and the card has been approved by their financial institution for such usage, the customer 4 enters their details as they appear on the EFTPOS/ATM card via the virtual pin-pad interface 2 using via their PC. The minimum information required to initiate a transaction using the virtual pin-pad 2 is the customer's ETPO/ATM card number and their PIN number. Once the customer 4 inputs their details, the server-side servers 8 undertake the financial transaction in the same manner as for debit or credit transactions.

### Balance Retrieval

The Balance Retrieval function of the virtual pin-pad 2 utilises almost identical functionality to the debit payment functionality in relation to the method for collecting the customer's banking details. Similarly, the entire transaction is undertaken such that the customer's details remain secure throughout the transaction process.

Once the customer details are input into the virtual pin-pad 2, the virtual pin-pad 2 sends the details via a secure link to the server-side servers 8 to use as part of the Internet Banking Processing Component installed on the servers 8. The customer's details are held in the server-side server memory 8 only long enough to complete a transaction and the result of the Balance Retrieval Transaction Processing is then displayed on the virtual pin-pad display.

### Server-Side Server System

There are three main web based applications hosted on the main server system 8, as shown in FIG. 3, being:

a. The virtual pin-pad web application

b. The SOAP web-service 14

c. The XML web-service 16

The server 8 runs the processes in order to service requests from the merchant 6 and customers 4. Each of the components hosted on the server 8 are responsible for communicating with a database within the server system 8 and are responsible for providing a means for logging all aspects of the operation of the system including transactions, sessions, exceptions and notifications.

Authentication is required before the virtual pin-pad 2 is launched and hence, an authentication token is a mandatory launch parameter which is sent from the SOAP Web Service 14 to the virtual pin-pad 2. The merchant 6 must therefore be capable of sending standards-compliant SOAP messages to the server-side 10 via the web-service so that the service can be used for authentication purposes. All requests are validated and only requests can be received from specific merchant IP addresses plus all communication is secured at the transport level via encryption methods. An alternative method of authenticating can be achieved using an XML web-service 16 which processes XML messages to and from the merchant 6.

A payment gateway 18 represents the processing gateway associated with the type of transaction that is being processed. For example, for credit card transaction processing it would represent the chosen credit card transaction processing service provider. Similarly, if the transaction was of an Internet Bank or EFTPOS type then this would represent the particular bank.

### Special Word Verification

The system employs a system capable of defeating Phishing sites which relies on the following:

1. Customer Registration

2. Customer Registered Card Number

3. Special Word Awareness

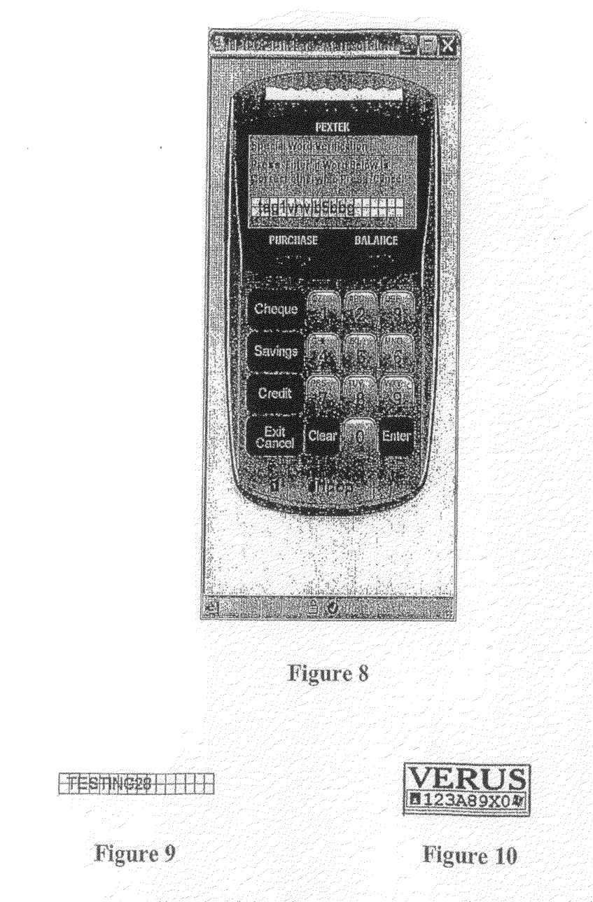

In order to use the system of the present invention a customer 4 must first register by providing personal details. During this registration process the customer 4 must decide on a special word and/or image which would be unique to the customer 4. Once the customer 4 is registered with the system, the customer 4 will also be capable of registering card numbers such as credit and/or debit card numbers. These card numbers will be used to determine whether or not they belong to a registered customer 4. When the system 1 detects that they do belong to a registered customer 4 then the system 1 will display the special word and/or image 80 given during registration as shown in FIGS. 8 and 9. If the word/image 80 displayed on the virtual pin-pad display to the customer 4 does not match the word/image 80 setup during the registration process then the customer 4 must close the virtual pin-pad 2 immediately. The virtual pin-pad 2 is closed as the Phishing site will not know this special word and/or image 80 and if it is not shown during the payment process, prior to giving card details or other personal details, then it is likely that the currently viewed pages are not genuine virtual pin-pad payment pages.

The virtual pin-pad system 2 relies on the customer 4 revealing their full debit card number for example; as this is required to lookup the customer specified special word and/or image 80. If a Phishing site replicates the same steps with a false special word and/or image then the customer 4 will realize this fact and as such the customer 4 has only exposed their card number and not all the details associated with the their card number such as CVV, expiry date and the name on the card.

Additionally, a registered customer 4 may choose to use a login name prior to giving card or account details before viewing their special word and/or image 80 thereby adding and additional layer of protection from fraud as no card or account details will be displayed until the customer 4 verifies or rejects the special word and/or image 80.

Utilising this method of customer verification differs to other systems that display dynamically generated images of unique text. These systems display the unique text for the client to re-enter and submit back to verify a client connection. In contrast to the anti-phishing measure used in the present invention assists in verifying, for the benefit of the customer 4, the authenticity of the web site. Hence, it employs the use of a dynamically generated image of text or other user specified object which allows the customer 4 to verify the authenticity of the virtual pin-pad 2 and web-site that they are using. The dynamically generated image is based on the customer's special word 80 established during customer registration and helps in establishing trust between the customer 4 and the virtual pin-pad site because of the privacy surrounding the customer's special word 80.

### Special Word Image Text

The customer's special word and/or image text 80 is sent by the virtual pin-pad server as an image to prevent easy recognition of ASCII text. The image is designed with anti-OCR techniques so as such the text looks unusual but is still capable of being read by the customer 4 as shown in FIG. 9. The image is then embedded in the virtual pin-pad display and the customer 4 is prompted to confirm whether the text/image corresponds to their special word 80 setup during registration. Further, to assist in defeating any OCR detection systems the text image 80 is covered in a grid 82, overlaid on top of the special word text 80.

The display of the image text will not occur until the customer 4 has entered all the digits of their card number and/or login and/or username which are submitted to the virtual pin-pad 2. The server-side server 8 then performs a lookup on the card number to see if they link and match with any registered customers. If a link is found to a registered customer 4 then the image text is generated dynamically and loaded. Whilst a special word 80 is preferred, a customer 4 also has the option of selecting and image or graphic instead of or including a special word 80.

### All Party Verification (APV)

The payment system 1 employs a visual identification verification method whereby a customer 4 is able to visually verify that all participating in a transaction are actually the identity they purport to be. A uniquely generated session graphic 90 containing information common to all parties is displayed on and across all web-based sites that are interacting or with whom the customer 4 is connecting to, an example of which is illustrated at FIG. 10.

The APV is similar to a security certificate in that it is deployed from a trusted source and has, in addition to a known name and brand, a unique value which is valid for the life of the session. The APV is displayed across multiple web-sites in a graphical form to provide a means for easy customer 4 verification. The uniquely generated graphic session 90 uses an APV message protocol to initiate the generation of the “session identification” graphic 90 to all parties for and subsequent to authentication.

If all certified graphic images 90 match as the customer navigates between web-based sites, then the customer 4 can be assured that the web-based sites displaying the matching APV's can be trusted without the need to understand IP number addresses, expiry dates and issuing authorities.

The session state is displayed either in a secure or insecure form through the graphical representation 90 as is the operating system and web-browser in use by the customer 4. If an APV image 90 is missing or does not match at any point during a customer's online session, then the user should quit the site immediately as the security of the web-based site cannot be guaranteed.

The key functional elements of the APV system include:
A multiple server authority check as opposed to a single level authority check.
A merchant via their web-site is responsible for the initiation of the customer transaction.
The customer can securely interact with two or more parties external to the merchant.
To use the system, each of the institutions must be reputable.
APV message protocol allows for authenticating connection between parties and communicating session identification graphic information across the parties.

### Phone Verification (PV)

The current two part verification system mentioned above may be the subject to “Man-In-The-Middle” (MITM) attacks. This occurs when a third party gets between two communicating parties and impersonates each end of the communications link to the other parties. This results in connections to both parties such that a third party can read and/or modify messages as they pass across the communications link whilst the two “authentic” parties think they are talking only to one another. Even if one party required the use of five passwords to gain access into a particular web site there still exists the serious problem of MITM attacks which are relatively easy to implement and render any elaborate password or secret code generator useless, even with limited lifetimes and use once only schemes. Hence, the passing of any information via the Internet from a compromised computer system may be at high risk of MITM attacks. Furthermore, all transactions whether from a compromised machine or not, may still be exposed to MITM attacks.

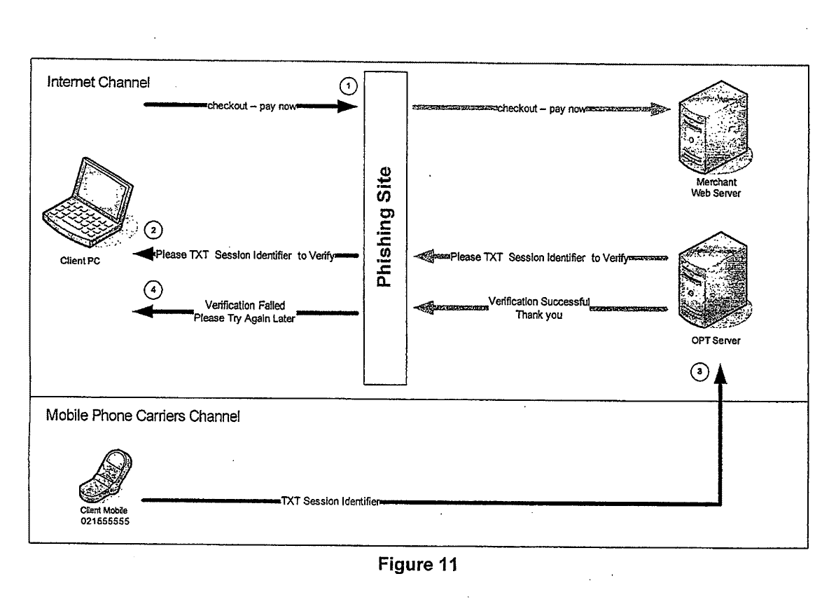

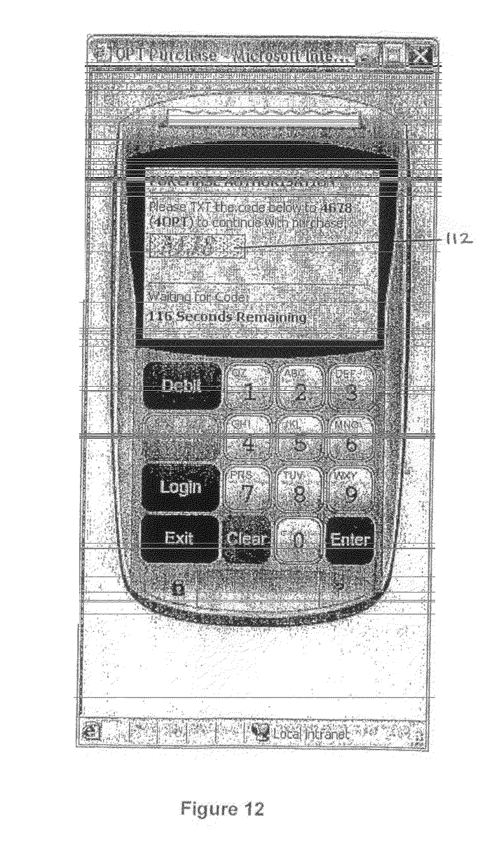

PV involves three parties and a multi-channel approach as shown in FIGS. 11 and 12, the client 4, the server-side server 8 and merchant system 6 which use one channel, the Internet. Additionally, the client 4 and the server-side server 8 use both the Internet and any one of the telecommunications carrier networks, which is preferably but not limited to a mobile telephone network and using these two channels to conduct system verification. An attack across the Internet channel and the phone carrier network channel within the limited lifespan of the transaction would be extremely complicated and very difficult to coordinate. Furthermore, an attack on or corruption of a mobile phone Short Message Service (SMS) text message must originate in the country where the text message service is located. In order for this system to be effective the following three factors are required:
1. Client registration of a mobile telephone number and or a land line telephone number during the registration process.
2. A merchant generated session identifier 112 which is generated by the server-side server 8.
3. A multi-channel information exchange approach.

A key objective is to eliminate any Internet based attacks on this PV mechanism thereby creating a secure way of authenticating a client 4 which can then be used to authorise online financial transactions, for example, funds transfer or online purchases as discussed above. Hence, by combining all the factors mentioned above into this PV mechanism will create a robust method is created for verifying online or remote transactions and verifying client identity.

During the customer registration process a client (user) 4 has the option to enable the authorisation of all purchases and other financial based transactions using a PV verification system. When PV has been selected, the system will enforce a PV action for all transactions originating from a merchant web-page or web-site 24 that support PV. Registered users will be given the option of setting financial limits such that any transactions above these limits will require PV. In order to successfully undertake a purchase using the PV system the following three processes must be undertaken:
1. A session identifier 112 is generated by the server-side server 8 and sent to the client's mobile phone 110 for display on the mobile phone screen 114.
2. On receipt of the session identifier 112, the client 4 texts the session identifier 112 back to the server-side server 8 using their mobile phone 110 in order to proceed and to authorise a purchase. Successful delivery of this information from the client 4 will complete the authorisation process.
3. On receipt of the session identifier text message from the client's mobile phone number, the server-side server 8 will undertake a client validation process. This is performed using the mobile phone number from which the text message was sent and using this information to compare the data stored in the server-side server database for the particular client 4.
4. There must be a match between the client's mobile phone number and session identifier 112 in order to complete the client authentication process.

Communication of the session identifier text message must be undertaken within a specific allocated time frame in order to create a more secure system and prevent replay attacks or duplicate message errors. Hence, the key to this verification mechanism is the content of the text message sent from the client 4. This content must contain the session identifier 112 that was generated by the server-side server 8.

### Merchant Check-Out Using PV

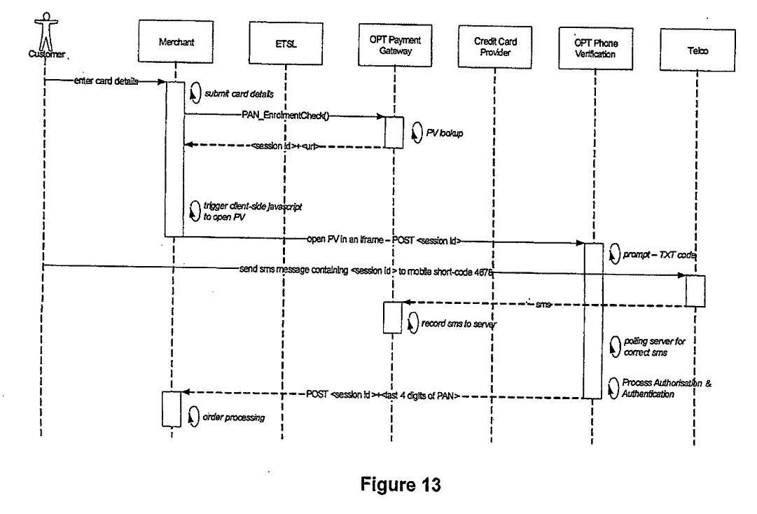

FIG. 13 outlines the processes that must be performed by an online merchant that supports PV for purchase verification and includes the normal purchase process (non-PV) discussed previously whereby once successful purchase verification is completed a merchant site is able to continue with the normal order processing steps.

Firstly, a client 4 initiates payment from a merchant checkout and in response the merchant site sends the PAN to the server-side server 8 that then checks if a card is enrolled in the PV scheme. A response code is returned to the merchant site that indicates the card enrolment status for a particular client 4 and if the client 4 is enrolled to use the PV system the server 8 will also return a session identifier 112 to the merchant site that will be used for client verification. This session identifier 112 corresponds to a unique interactive session with a specific merchant. The online payment system prompts the client 4 to send a text message to a specific number for example, short code 4678, containing the session identifier 112. A count down in seconds is displayed on screen and feedback is displayed indicating the online payment system is waiting to receive the session identifier text message from the client. Once the server-side server 8 receives the session identifier text message sent by the client, the server-side server 8 retrieves the client details from the server-side server database, compares the client's mobile phone number with the database record. Furthermore, the online payment system verifies that the received session identifier corresponds with the session identifier 112 sent to the client 4 in order to complete validation process by the server-side server 8. The server-side server 8 will send a further message to the client 4 indicating receipt of the session identifier text message and the outcome of validation process. The client 4 is permitted to resend the session identifier text message three times within the specified timeout period (which is displayed as a decreasing count on the client's mobile phone display) only if the text messages received are originating from the correct and identical phone number. The server-side server 8 also simultaneously posts the result of PV verification to the merchant site enabling the order processing to process as normal. If the PV verification is unsuccessful, the merchant is required to cancel the purchasing transaction immediately.

Using the PV system a merchant can not proceed with a purchasing transaction until the requisite PV authentication and validation information has been received by the merchant site from the server-side server 8. In the event that a session identifier text message send from a mobile phone number is correct but the mobile phone number from which the message is sent does not correspond to the mobile phone number detailed, in the customer's server-side server database record, the transaction will immediately be deemed invalid.

### Session Timeout

When a session exceeds a timeout value of 20 seconds, the server-side server 8 will perform a clean-up on the customer's session and record the timeout in the server database. Any subsequent requests from the virtual pin-pad 2 will result in a response from the server 8 that the session has timed out Session timeouts include sessions which have been terminated on the client side 12. If client 12 does not receive a response from the server-side servers 8 within the timeout period then the session is forced to timeout and the virtual pin-pad 2 will cancel the customer's transaction and the virtual pin-pad 2 will close down.

Timeouts will also occur if customer requests are received too fast and as been configured to prevent any automated “spoofs” or “hijacking” of the virtual pin-pad sessions. If the server-side server 8 receives a request from the customer 4 within a 2 second period then the virtual pin-pad session is aborted and an error response sent to the customer 4. Also, when a response from the server-side server 8 exceeds 9 seconds then the customer-side server 12 is set to a timeout mode and the virtual pin-pad 2 is locked and closes down after 10 seconds have elapsed if the browser window 26 is still active.

Although the invention has been described by way of example and with reference to particular embodiments, it is to be understood that modifications and/or improvements may be made without departing from the scope or spirit of the invention.

1-41. (canceled)

42: A user activated payment system for use when purchasing goods and/or services from a remote computerised vendor system comprising:
an electronic input means providing said user with a means to provide input to said remote computerised vendor system,
a virtual terminal residing on said remote computerised vendor system capable of being activated by said user using said electronic input means, to undertake financial transactions under the control of a third party transaction system, and
at least one database record located on said third party transaction system corresponding to the said user's identity and used to identify said user and sending said user a unique user specified word for display on said virtual terminal corresponding to said user's identity thereby enabling said user to operate said virtual terminal to undertake said financial transactions.

43: The user activated payment system according to claim 42 wherein said at least one database record on said third party transaction system is used to record a user's details including a unique word which is specified by said user and is displayed on said virtual terminal prior to said financial transactions being performed enabling said user to verify their identity.

44: The user activated payment system according to claim 42 wherein said unique user specified word is a sequence of alpha-numeric characters.

45: The user activated payment system according to claim 42 wherein said unique user specified word is a sequence of alpha-numeric characters which is transformed into a unique image.

46: The user activated payment system according to claim 42 wherein said virtual terminal will be deactivated by said user if said user specified word displayed on said virtual terminal does not correspond to said unique user specified word recorded in said at least one database record.

47: The user activated payment system according to claim 42 wherein said virtual terminal comprises at least a data input means, an account selection means, user functionality means and a user feedback means.

48: The user activated payment system according to claim 47 wherein said data input means comprises a plurality of virtual alpha-numeric keys.

49: The user activated payment system according to claim 47 wherein said account selection means includes a plurality of virtual financial account keys.

50: The user activated payment system according to according to claim 49 wherein said virtual financial account keys enable said user to select to undertake said financial transaction by selecting either a cheque account, a credit account or a savings account from which funds can be withdrawn.

51: The user activated payment system according to claim 47 wherein said functionality means includes a plurality of keys which when activated, enable said user to perform a plurality of actions such as erasing information, exiting a particular transaction and terminating a transaction session.

52: The user activated payment system according to claim 47 wherein said user feedback means comprises a virtual display.

53: The user activated payment system according to claim 42 wherein said virtual terminal can be customised to meet a merchant's business requirements.

54: A method of undertaking a user activated payment for making financial transactions online on gaining access to a remote computerised vendor system comprising the steps of:
activating a virtual terminal on said remote computerised vendor system,
inputting data on said virtual terminal to undertake a financial transaction with said remote computerised vendor system via a third party transaction system, and
wherein said user inputs data to said virtual terminal to select a financial institution which provides an online financial transaction service through which said user performs all their financial transactions and on selection said user may perform a financial transaction in order to purchase goods and/or services using said third party transaction system as a payment gateway and on completion of said financial transaction, deactivating said virtual terminal.

55: The method of undertaking a user activated payment according to claim 54 wherein said step of activating said virtual terminal is by said user activating a web-based browser window from within a web-page activated on said remote computerised vendor system.

56: The method of undertaking a user activated payment according to claim 54 wherein said step of inputting data on said virtual terminal causes said virtual terminal to interact with said third party transaction system to provide a payment gateway between said user and said remote computerised vendor system.

57: The method of undertaking a user activated payment according to claim 56 wherein said step of inputting data on said virtual terminal requires said third party transaction system to temporarily store in a database said user's financial transaction information.

58: The method of undertaking a user activated payment according to claim 56 wherein said step of inputting data on said virtual terminal requires said third party transaction system to provide a means of enabling said user to validate their identity via said virtual terminal.

59: The method of undertaking a user activated payment according to claim 56 wherein said step of inputting data enables said user to validate their identity when said third party transaction system sends a word for display on said virtual terminal whereby said word corresponds to a word determined by said user during a system registration process enabling said user to proceed with said financial transaction.

60: The method of undertaking a user activated payment according to claim 56 wherein said step of inputting data enables said user to not validate their identity if said word sent by said third party transaction system does not correspond to said word determined by said user during said system registration enabling said user to terminate said financial transaction.

61: The method of undertaking a user activated payment according to claim 56 wherein said step of inputting data requires a further step of enabling said user to validate their identity using a telecommunications device requiring said third party transaction system to provide a means for enabling said user to validate their identity via said telecommunications device.

62: The method of undertaking a user activated payment according to claim 61 wherein said further step of inputting data which enables said user to validate their identity using a telecommunications device when said third party transaction system sends a unique session word for display on said telecommunications device whereby said unique session word corresponds to a unique session word which corresponds to an interactive session word unique to said remote computerised vendor system enabling said user to proceed with said financial transaction.

63: The method of undertaking a user activated payment according to claim 61 wherein said further step of inputting data which enables said user to not validate their identity using a telecommunications device if said user does not resend said unique session word sent by said third party transaction system back to said third party transaction system and said unique session word does not correspond to said unique session word sent to said telecommunications device said financial transaction is terminated.

64: The method of undertaking a user activated payment according to claim 54 wherein said step of performing said financial transaction is completed when said third party transaction system provides said remote computerised vendor system with a valid transaction indication.

65: The method of undertaking a user activated payment according to claim 54 wherein said step of performing said financial transaction is completed when said third party transaction system provides said remote computerised vendor system and said user with a valid transaction indication.

66: A method of making a financial transaction online using a virtual terminal activated from a web-based system residing on a remote computerised vendor system comprising the steps of:
selecting a product and/or service online from said web-based system activated on said remote computerised vendor system,
activating said virtual terminal from said web-based system,
selecting a financial institution and an account type from a menu on said virtual terminal,
inputting on said virtual terminal a user's primary authentication information enabling said user to gain access to said account type,
receiving and displaying a user verification data on said virtual terminal,
verifying said user verification data,
receiving and displaying a security certificate which is common to each web-based site interacting with said user,
verifying said security certificate each time said user interacts with each of said web-based site,
confirming details of said financial transaction,
receiving a confirmation that said financial transaction has been accepted, and
deactivating said virtual terminal on completion of all of said transactions.

67: The method of making a financial transaction online according to claim 66 wherein said step of receiving a confirmation requires said third party transaction system to send a transaction acknowledgement to said remote computerised vendor system enabling said remote computerised vendor system to complete a user purchase transaction.

68: The method of making a financial transaction online according to claim 66 wherein said step of inputting a user's primary authentication information includes said user inputting a user card number and a form of a coded user identifier information.

69: The method of making a financial transaction online according to claim 66 wherein said step of inputting a user's primary authentication information includes said coded user identifier information comprising a user name and/or password.

70: The method of making a financial transaction online according to claim 66 wherein said step of confirming details of said transaction requires said user to confirm said transaction type is a purchase payment for goods and/or services.

71: The method of making a financial transaction online according to claim 66 wherein said step of confirming details of said transaction requires said user to confirm said transaction type is a balance query in relation to one of said account types.

72: The method of making a financial transaction online according to claim 66 wherein said step of verifying said user verification data requires said user to verify a word specified by said user when said user becomes a registered user of said third party transaction system is correct.

73: The method of making a financial transaction online according to claim 72 wherein said step of verifying said verification data requires said third party transaction system to code said user specified word into a form which said user can understand before sending said user specified word to said virtual terminal for said user to verify as being their user specified word.

74: The method of making a financial transaction online according to claim 72 wherein said step of verifying said verification data requires said user to deactivate said virtual terminal if said user specified word does not correspond to said user specified word sent to said virtual terminal.

75: The method of making a financial transaction online according to claim 72 wherein said step of verifying said security certificate requires said user to verify a uniquely generated session graphic common to each of said web-based sites interacting with said user enabling said user to verify and authenticate said web-based sites.

76: The method of making a financial transaction online according to claim 72 wherein said step of verifying said security certificate requires said user to deactivate said virtual terminal is said uniquely generated session graphic does not correspond to said uniquely generated session graphic common to each of said web-based sites interacting with said user.

77: The method of making a financial transaction online according to claim 72 wherein said further step of verifying said user verification data requires said user to send a unique session word received from and generated by said third party transaction system, back to said third party transaction system to further authenticate said user.

78: The method of making a financial transaction online according to claim 77 wherein said step of verifying said user verification data requires said user to not send said unique session word received from and generated by said third party transaction system, back to said third party transaction system to terminate said financial transaction.

79: The method of making a financial transaction online according to claim 66 wherein said step of selecting an account type requires said user to select a debit account.
